(19) United States
(12) Patent Application Publication
(10) Pub. No.: US 2025/0103773 A1
(43) Pub. Date: Mar. 27, 2025

(54) 3-D LATTICE OPTIMIZATION

(71) Applicant: Ocado Innovation Limited, Hatfield (GB)

(72) Inventor: Chiara CECCATO, Bedford (GB)

(21) Appl. No.: 18/972,802

(22) Filed: Dec. 6, 2024

Related U.S. Application Data
(63) Continuation of application No. PCT/EP2023/064611, filed on May 31, 2023.

(30) Foreign Application Priority Data
Jun. 9, 2022 (GB) 2208481.8
Jul. 15, 2022 (GB) 2210399.8

(51) Int. Cl. G06F 30/23; G06F 111/08; G06F 113/10

(52) U.S. Cl. CPC G06F 30/23; G06F 2111/08; G06F 2113/10

(57) ABSTRACT

A computer implemented method for efficiently generating an optimized design of a component comprising a lattice structure.

### CROSS-REFERENCE TO RELATED APPLICATIONS

This application is a continuation of International Patent Application No. PCT/EP2023/064611, filed on May 31, 2023, which claims priority to UK Application No. 2208481.8, filed on Jun. 9, 2022, and UK Application No. 2210399.8, filed on Jul. 15, 2022, the entire contents of each of which are hereby incorporated by reference.

### BACKGROUND

### Technical Field

Aspects relate to the computationally efficient simulation of a component. A design obtained from the simulation can be manufactured using additive manufacturing (AM) techniques, such as Multi Jet Fusion (MJF) or Selective Laser Sintering (SLS) to form a component that has at least one optimized mechanical property.

### Description of Related Art

It is known to use Topology Optimization (TO) to reduce the weight of a component. Although TO allows for significant weight reduction in comparison to respective homogeneous parts, it fails to account for heat warping and distortion effects in an MJF printing process. Such effects result in significant discrepancies between a component design derived from TO and the component design printed using MJF. These discrepancies may result in a printed MJF component that does not meet acceptable manufacturing tolerances.

Natural cellular materials, such as wood, sponge, or cork, have been used in a broad range of modern engineering materials, including stochastic polymeric foams and honeycomb cores used in composite panels. Cellular materials can exhibit a range of unique and advantageous property combinations, e.g. high strength and stiffness-to-weight ratio, superior energy and heat dissipation or large recoverable strains in structures made from brittle material. Lattice structures are cellular materials distinguished by a regular structure created by tessellating frames of struts or plates (unit cells) in 2D or 3D space. Due to recent advancements in AM techniques, the use of lattice structures are better suited for the design of lightweight components. Specifically, lattice structures reduce energy and material expenditures during manufacturing, and also offer properties that are unattainable with homogeneous materials, for example, negative Poisson's ratio.

Accordingly, the use of infill lattice structures has been proposed as an alternative method of reducing the weight of a component that is manufactured using MJF. As shown in FIG. 1, a component has a gyroid lattice infill. Due to lattice structures having a high surface area to volume ratio, heat dissipation is facilitated in the MJF printing process. Such heat dissipation may prevent heat warping and distortion during the MJF printing process such that a printed MJF component has acceptable manufacturing tolerances.

Modelling complex lattice structures relies on computationally heavy simulations, making the accurate evaluation and optimization of their mechanical performance extremely time-consuming. Therefore, a computationally efficient and accurate optimization approach is required to develop and manufacture components with in-fill lattice structures with optimal mechanical performance to weight ratios. Such components may be used in a load handling device such as that described in UK Patent Application No. GB2520104A (Ocado Innovation Limited). A load handling device is an automated system having moving components/parts. Such components/parts can be made lighter using lattice structures, which in turn makes the load-handling device more efficient.

### SUMMARY

In one aspect, there is a computer implemented method for optimizing a design of a component, the method comprising: a) using a homogenization algorithm to determine at least one first parameter of a selected unit cell lattice structure; b) using the at least one first parameter as an input to a topology optimization algorithm to determine at least one second parameter of a component with the selected lattice structure; c) using the at least one second parameter to define a functional grading of the component; d) using a finite element analysis algorithm to evaluate a component based on the functional grading to derive objective values; e) using the objective values in a Bayesian optimization algorithm to weight the at least one second parameter; and f) iteratively performing steps c) to e) to generate an optimized design of the component comprising the selected lattice structure. This means processing and memory resources are minimized when optimizing the design of a component. The accuracy of the optimization is maintained.

The at least one first parameter may comprise one or more of: a penalty exponent that characterises a relationship between a stiffness and a density of the unit cell lattice structure, a design domain that defines design and non-design volumes of the component, loading conditions, and boundary conditions. This means the component can be optimized for a given target use.

The at least one second parameter may comprise one or more of a topology optimized density/greyscale field, a shape of the component, and a stress field. This provides an initial optimization that lends itself to further optimization.

The topology optimized density/greyscale field and the stress field may be combined to form the functional grading. This means that regions of the component where the functional grading take high values should be assigned a high relative density.

The functional grading may be defined by:

$$ℱ ( x , y , z ) = {w}_{1} \cdot 𝒳 ( x , y , z ) + ( 1 - {w}_{1} ) \cdot 𝒴 ( x , y , z )$$

where [symbol] (x, y, z) represents the topology optimized density/greyscale field, [symbol] (x, y, z) represents the stress field, and w₁ is a weighting factor to weight the at least one second parameter. This provides a simple and less optimal solution, but one which is satisfactory in certain scenarios.

The functional grading may be defined by:

$$ℱ ( x , y , z ) = [ {w}_{0} {w}_{1} {w}_{2} {w}_{3} {w}_{4} {w}_{5} ] [ \begin{matrix}1 \\ 𝒳 \\ 𝒴 \\ {𝒳}^{2} \\ {𝒴}^{2} \\ 𝒳𝒴\end{matrix} ]$$

where [symbol] (x, y, z) represents the topology optimized density/greyscale field, [symbol] (x, y, z) represents the stress field, and w₀, w₁, w₂, w₃, w₄, w₅ are weighting factors to weight the at least one second parameter. This means the search space is limited so the Bayesian optimization performance is enhanced.

$$ℱ ( x , y , z ) = [ {w}_{0} {w}_{1} {w}_{2} {w}_{3} {w}_{4} {w}_{5} ] [ \begin{matrix}1 \\ 𝒳 \\ 𝒴 \\ {𝒳}^{2} \\ {𝒴}^{2} \\ 𝒳𝒴\end{matrix} ]$$

may be constrained by the following equation:

$${ℱ}^{*} ( x , y , z ) = min ( max ( ℱ ( x , y , z ) , 0 ) , 1 ) .$$

This means the Bayesian optimization does not explore unfeasible solutions which further improves its performance.

The average value of [symbol] (x, y, z) within a lattice region of the component may be constrained to [0, 1], wherein the average value is defined by:

$$𝔼 [ ℱ ( x , y , z ) ] = [ {w}_{o} {w}_{1} {w}_{2} {w}_{3} {w}_{4} {w}_{5} ] [ \begin{matrix}1 \\ 𝔼 [ 𝒳 ] \\ 𝔼 [ 𝒴 ] \\ 𝔼 [ {𝒳}^{2} ] \\ 𝔼 [ {𝒴}^{2} ] \\ 𝔼 [ 𝒳𝒴 ]\end{matrix} ] ,$$

where

$$𝔼 [ 𝒳 ( x , y , z ) ] = \frac{{\int }_{{V}_{LR}} 𝒳 ( x , y , z ) dV}{{V}_{LR}} , 𝔼 [ 𝒴 ( x , y , z ) ] = \frac{{\int }_{{V}_{LR}} 𝒴 ( x , y , z ) dV}{{V}_{LR}} , \\ 𝔼 [ {𝒳}^{2} ( x , y , z ) ] = \frac{{\int }_{{V}_{LR}} {𝒳}^{2} ( x , y , z ) dV}{{V}_{LR}} , 𝔼 [ {𝒴}^{2} ( x , y , z ) ] = \frac{{\int }_{{V}_{LR}} {𝒴}^{2} ( x , y , z ) dV}{{V}_{LR}} , \\ and 𝔼 [ 𝒳𝒴 ( x , y , z ) ] = \frac{{\int }_{{V}_{LR}} 𝒳𝒴 ( x , y , z ) dV}{{V}_{LR}} ,$$

where V_{LR} is the volume in a lattice region of the component. This means the Bayesian optimization does not explore unfeasible solutions which further improves its performance.

Generating the optimized design may comprise generating a plurality of optimized designs, and the method further comprises generating a Pareto front from the plurality of optimized designs, and selecting one of the optimized designs from the Pareto front using a technique for order preference by similarity to an ideal solution, TOPSIS, algorithm. This means a number of optimized designs can be analysed to select a final optimized design.

Steps c) to e) may be run in parallel to evaluate a number of components concurrently. This reduces the overall time taken to derive the optimized design.

The component may comprise an infill lattice structure. This means heat can dissipate during an additive manufacturing process.

In another aspect, there is a method of manufacturing a component, wherein the method comprises obtaining an optimized design of the component using the method of any of the above aspects, and manufacturing the optimized design. This means the component achieves a desired weight reduction whilst meeting certain performance characteristics such as stiffness.

The component may be manufactured using additive manufacturing such as MJF or SLS. This means the printed component meets acceptable manufacturing tolerances and constraints.

In another aspect there is a computer program comprising instructions which, when the program is executed by a computer, cause the computer to carry out the method of any of the above aspects.

In another aspect, there is a data processing system comprising means for carrying out the method of any of the above aspects.

In another aspect, there is a mobile grocery picking robot or a load handling device having a component designed by the method of any of the above aspects.

### DESCRIPTION OF THE DRAWINGS

The appended figures depict certain aspects and are therefore not to be considered limiting of the scope of this disclosure.

FIG. 1 is an example of an infill lattice structure;

FIG. 2 shows example unit cells;

FIG. 3 shows the steps of a computationally inexpensive optimization algorithm;

FIG. 4 shows a method of manufacturing a component using the algorithm of FIG. 3; and

FIG. 5 shows a component manufactured using the method of FIG. 4.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

### Efficiency-Accuracy Trade-off

As mentioned above, a computationally efficient and accurate optimization approach is required to develop components with infill lattice structures with optimal mechanical performance to weight ratios.

Typically, lattice structures themselves are modelled using homogenization where heterogeneous lattice structures are considered at the macroscopic scale and modelled as a homogeneous material of equivalent properties. Although such an approach has low computational cost, it fails to capture edge effects in finite lattices and is unsuitable for lattice infills with a small number of unit cells across a width. For example, a lattice structure must have at least a 4×4×4 tessellation of diamond unit cells for its stiffness to be within 0.4% of the modelled homogenized result. In other words, a minimum number of unit cells is required to render the modelling accurate. Thus, modelling using homogenization reduces design freedom in selecting the number of unit cells.

Finite Element Analysis, FEA, can be used to model lattice structures, with superior modelling accuracy compared to modelling using homogenization. By way of comparison, a structure having a 2×2×2 tessellation of octet truss unit cells modelled using both homogenization and FEA shows that the former technique significantly underestimates the structure's stiffness, as it predicts higher displacements and lower maximum von Mises stress, compared to the latter technique. However, the computation time required for the latter technique is an order of magnitude longer compared to the former technique. The selection of modelling using homogenization or FEA is an accuracy-efficiency trade-off.

Hybrid approaches which combine the above modelling techniques have been proposed, but again such techniques involve a trade-off between accuracy and computational expense. For example, one hybrid technique, whilst reducing the time taken, performs poorly when modelling stiffness accurately. Further techniques improve accuracy but at significant computational expense.

The ability to accurately capture edge effects and stress concentrations in finite lattice infills is crucial for the design of components. However, the current computational costs are significant. A simulation that achieves similar, if not greater, accuracy than known techniques, whilst also reducing the computational expense (i.e. lower processor and memory usage) is desirable.

In accordance with the aspects described herein there is provided a simulation that avoids the accuracy-efficiency trade-off. The computing expense of the simulation is reduced without affecting the accuracy of the simulation. Thus, a component manufactured based on the simulation will perform as predicted by the simulation. Components with at least one optimized mechanical property can be obtained.

### Computationally Inexpensive Optimization Algorithm

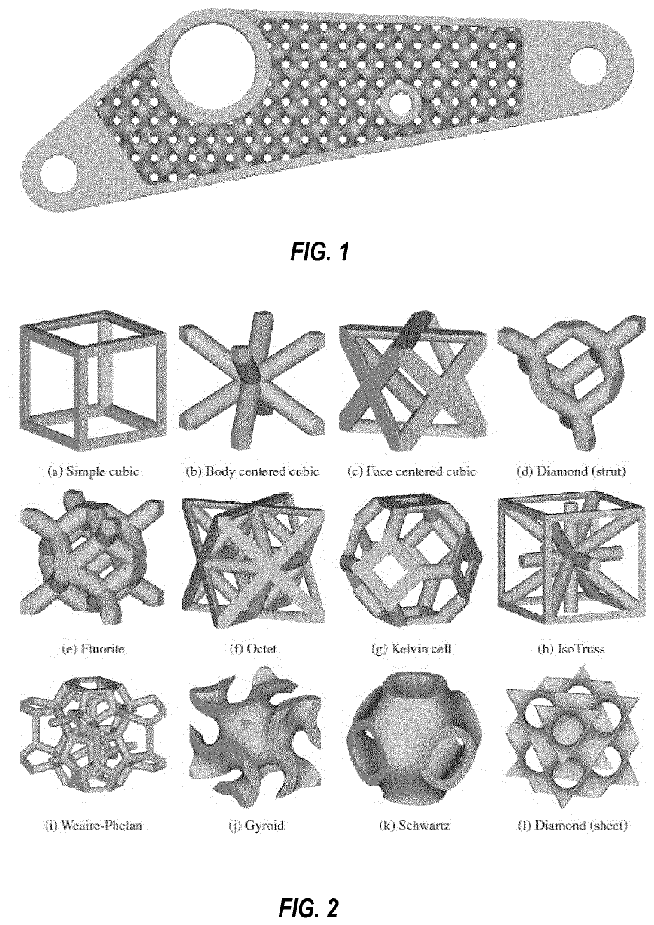

FIG. 1 shows the steps of an optimization algorithm 100 that minimizes computational expense without reducing accuracy. Whilst an algorithm could be designed to run with no time constraints, a key aim with the present method and system is to reduce the time taken. This way, the simulation lowers the processing and memory usage. The algorithm of FIG. 1 combines algorithms in a way that exploits their strengths in terms of efficiency and accuracy.

The steps of the optimization algorithm are:

Step 1: A unit cell type for the lattice infills is selected 110. Example unit cell types are shown in FIG. 2. Each of these unit cell types represent candidate lattice structures that can be used as an infill lattice structure in a component. As shown, the unit cell types include simple cubic, body centered cubic, face centered cubic, diamond (strut), fluorite, Octet, Kelvin cell, IsoTruss, Weaire-Phelan, Gyroid, Schwartz, and Diamond (sheet). It would be appreciated that the depicted cells are exemplary, and the skilled person could readily explore a myriad of unit cells. The selection of the unit cell could be based on stiffness, heat dispersion, or post MJF powder removal properties for example.

Step 2: A homogenization algorithm is used to determine at least one first parameter of the selected unit cell lattice structure 110. It would be appreciated that step 1 can occur as part of the homogenization algorithm. The purpose of step 2 is to generate at least one first parameter to characterize the selected unit cell. As an example, the at least one first parameter is a penalty exponent that characterizes a relationship between stiffness and density of the unit cell lattice structure. An example homogenization algorithm that can be used is that provided by nTopology™ software. Step 2 represents a computationally efficient way of generating the at least one first parameter.

Step 3: A Topology Optimization, TO, algorithm uses the at least one first parameter to determine material distribution in a component using infill lattice structures for a design volume, optimization objectives, loads, boundary conditions, and constraints 120. It would be appreciated that setting the design volume, optimization objectives, loads, boundary conditions, and constraints is dependent on a target use, and can be selected accordingly. Example objectives include displacement minimization under certain loading conditions, mass reduction, and reduced heat warping (i.e. maximize surface area to volume ratios of the lattice structures). Example constraints include minimum mass reduction compared to original design volume, type of MJF printer (e.g. HP Jet Fusion 5200 Series Industrial 3D Printer with nylon PA12), maximum stress value, duty-cycle robustness, maximum displacement, compliance with a system in which component is used. The purpose of step 3 is that the TO algorithm can accurately represent and adjust for elastic behavior of the selected unit cell (as defined by the at least one first parameter). Step 3 provides an initial TO result of the component. The TO algorithm generates at least one second parameter to characterize the component. An example TO algorithm that can be used is the Solid Isotropic Material with Penalization, SIMP, algorithm, provided by ANSYSM software.

Step 4: The at least one second parameter is used to define a functional grading of the component 130. For example, a density/greyscale solution and a stress field obtained from step 3 are combined to generate the functional grading. The density/greyscale solution may be further transformed before combining with the stress field. In one example, the density/greyscale solution is translated into a scalar field using interpolation between nodes. In another example, the stress field is a von Mises stress field. A stiffness optimal density field from step 4 is used to determine a shape of the component by applying a threshold that results in a solid-void solution. The resulting shape is smoothened using a Gaussian filter. Using the determined shape, the von Mises stress field incurred by the loading conditions is obtained. Alternatively, a field describing the thermal gradients in a component during the AM (e.g. MJF) printing process could be combined with a TO density/greyscale solution to find the optimal trade-off between the component's heat warping and its stiffness response. In general, scalar fields representing features related to the optimization objectives are combined to form the functional grading. As mentioned above, the optimization objectives can be selected according to the target use of the component. It can thus be appreciated how the at least one second parameter (e.g. density/greyscale solution and/or the stress field) can be readily used to define the functional grading. Step 4 allows the initial TO result of the component to be characterized in a way that avoids further analysis that otherwise would be computationally expensive. In other words, this step serves to reduce the amount of overall processing required in the simulation. An initial weighting may be applied to the functional grading. It would be appreciated that the initial weighting may be 1, which is equivalent to applying no weighting.

Step 5: An FEA algorithm is used to evaluate a component based on the functional grading to derive objective values 140. Whilst somewhat computationally expensive, step 5 accurately predicts the performance of the component by comparing the objective values against the optimization objectives. An example FEA algorithm that can be used is that provided by nTopology™ software.

Step 6: A Bayesian optimization algorithm uses the objective values to weight the functional grading 150. Step 6 adjusts the functional grading based on the optimization objectives. It has been found that Bayesian optimization is particularly suited to adjusting the functional grading in terms of computational efficiency. Facebook™ Open Source's Ax platform for Python is an example software that can be used for the Bayesian optimization.

Step 7: Steps 4 to 6 are iteratively performed 160 to generate an optimized design of the component comprising the selected lattice structure 170. In other words, steps 4 to 6 are repeated until the design is optimized. It can be appreciated that the computationally efficient Bayesian optimization can be used to offset the otherwise high computational cost of step 5 by limiting the number of evaluations in the optimization process.

Step 8: This step is optional and is only required if more than one optimized design is generated by the above steps. The more than one optimized design is used to generate a Pareto front. A final optimized design can be selected from the Pareto front using a technique for order preference by similarity to an ideal solution, TOPSIS, algorithm.

It has been found that the above steps result in a computationally efficient algorithm. The initial TO result of step 3 is generated as efficiently and accurately as possible since it uses a penalty exponent (i.e. the at least one first parameter) specific to lattice structures. Step 6 is particularly advantageous. One simulation implementation of a cantilever beam meant that the FEA algorithm of step 5 involved 100 search points to optimize the design, whereas absent the Bayesian Optimization of step 6, the FEA algorithm of step 5 would involve ˜400,000,000 search points. The difference in computing resources required for an FEA algorithm that involves 100 and ˜400,000,000 search points is vast. As set out below, simulated characteristics of the component are found to match those of a component manufactured using MJF, thus showing the accuracy of the above algorithm.

### Functional Grading and Bayesian Optimization

As mentioned above, the Bayesian optimization is particularly suited in terms of improving computational efficiency when adjusting the functional grading. Scalar fields representing features related to the optimization objectives are weighted and combined to form a functional grading. The weighting of functional grading is based on the principle that the regions where the input fields take high values should be assigned high relative density. For example, regions of high stress should be infilled with a high density lattice structure to minimize the peak stress in the component.

Any scalar field, [symbol] (x, y, z), with values between 0 and 1 can be used to drive the relative density of the lattice structure. In practice, the range (i.e. max and min) of relative densities realizable with lattice structures is bounded by the manufacturing constraints on the smallest member size, cell, enclosure etc. To respect these constraints, the relative densities is defined by the following formula,

$$ρ ( x , y , z ) = {ρ}_{min} + ( {ρ}_{max} - {ρ}_{min} ) \cdot ℱ ( x , y , z ) \qquad ( 1 )$$

where ρ represents relative density, or alternatively

$$ρ ( x , y , z ) = min [ max [ {ρ}_{min} , ℱ ( x , y , z ) ] , {ρ}_{max} ] \qquad ( 2 )$$

The functional grading field, [symbol] (x, y, z), is constructed as a combination of two fields, [symbol] (x, y, z) representing the density/greyscale field, and [symbol] (x, y, z) representing the stress field of the component (e.g. von Mises stress distribution), derived from the TO of step 3. Notably, both [symbol] and [symbol] fall within the [0, 1] range and could be used individually to drive the functional grading [symbol] .

The simplest combination of fields [symbol] and [symbol] , which itself constitutes a valid functional grading field is

$$ℱ ( x , y , z ) = {w}_{1} \cdot 𝒳 ( x , y , z ) + ( 1 - {w}_{1} ) \cdot 𝒴 ( x , y , z ) \qquad ( 3 )$$

where w₁ is a weighting factor and w₁∈[0,1]. Such a combination ensures all field values are within the required range. However, the combination based on a single parameter is expected to have a reduced expressive power, i.e. the ability to generate a wide family of functional grading fields. However, this might provide an acceptable solution in certain scenarios. To alleviate this issue, the linear combination from Eq. (3) is may be replaced with a quadratic polynomial in two fields

$$ℱ ( x , y , z ) = ⌊ {w}_{o} {w}_{1} {w}_{2} {w}_{3} {w}_{4} {w}_{5} ⌋ [ \begin{matrix}1 \\ 𝒳 \\ 𝒴 \\ {𝒳}^{2} \\ {𝒴}^{2} \\ 𝒳𝒴\end{matrix} ] \qquad ( 4 )$$

where w₀, w₁, w₂, w₃, w₄, w₅ are weighting factors, wᵢ∈[−1,1]. w₀ can be used as a bias term to ensure that uniformly dense lattices can be represented. The squared fields, [symbol] ² and [symbol] ² share the patterns of the original fields, but assign lower relative density values throughout, and [symbol] [symbol] field can be interpreted as a measure of similarity between the two fields.

To ensure that equation (4) is within a [0,1] range, it was numerically constrained by

$${ℱ}^{*} ( x , y , z ) = min ( max ( ℱ ( x , y , z ) , 0 ) , 1 ) \qquad ( 5 )$$

Further trials have shown that the sum of weights (w₀, w₁, w₂, w₃, w₄, w₅) must also be constrained. Otherwise, the design space is dominated by weight combinations, for which the entire grading field [symbol] (x, y, z) takes values outside of the [0, 1] range, and the trimmed [symbol] *(x, y, z) takes either a uniform 0 or 1 field. Uniform fields are of minimal interest to optimization and should be avoided. Having multiple parametrizations that result in the same objective values is not recommended as Bayesian optimization is likely to encounter them more than once in exploring the design space, even though they cannot offer an improvement after they are evaluated at least once. To limit the occurrence of uniform [symbol] (x, y, z) fields, the average value of [symbol] (x, y, z) within the lattice region is constrained to [0, 1], wherein the average value is defined by:

$$𝔼 [ ℱ ( x , y , z ) ] = [ {w}_{o} {w}_{1} {w}_{2} {w}_{3} {w}_{4} {w}_{5} ] [ \begin{matrix}1 \\ 𝔼 [ 𝒳 ] \\ 𝔼 [ 𝒴 ] \\ 𝔼 [ {𝒳}^{2} ] \\ 𝔼 [ {𝒴}^{2} ] \\ 𝔼 [ 𝒳𝒴 ]\end{matrix} ] \qquad ( 6 )$$

where

$$𝔼 [ 𝒳 ( x , y , z ) ] = \frac{{\int }_{{V}_{LR}} 𝒳 ( x , y , z ) dV}{{V}_{LR}} , 𝔼 [ 𝒴 ( x , y , z ) ] = \frac{{\int }_{{V}_{LR}} 𝒴 ( x , y , z ) dV}{{V}_{LR}} , \\ 𝔼 [ {𝒳}^{2} ( x , y , z ) ] = \frac{{\int }_{{V}_{LR}} {𝒳}^{2} ( x , y , z ) dV}{{V}_{LR}} , 𝔼 [ {𝒴}^{2} ( x , y , z ) ] = \frac{{\int }_{{V}_{LR}} {𝒴}^{2} ( x , y , z ) dV}{{V}_{LR}} , \\ and 𝔼 [ 𝒳𝒴 ( x , y , z ) ] = \frac{{\int }_{{V}_{LR}} 𝒳𝒴 ( x , y , z ) dV}{{V}_{LR}} ,$$

where V_{LR} is the volume in a lattice region.

The constraint on the average value of the grading field can be expressed in terms of the weights (w₀, w₁, w₂, w₃, w₄, w₅), and therefore can be enforced by restricting parametrisations that are proposed in the BO algorithm.

The derivation of the functional grading described above was developed specifically to comply with computational requirements of the Bayesian optimization algorithm. Ensuring that the number of optimized parameters (i.e. w₀, w₁, w₂, w₃, w₄, w₅) is small, and limiting the search space to a 6-dimensional hypercube has a positive effect on the Bayesian optimization performance, which has been found to reach an optimal solution for a complex component after generating 100 search points for the FEA algorithm of step 5 to evaluate. Absent the Bayesian optimization, the FEA algorithm would be required to evaluate ˜400,000,000 search points instead. The difference in computing resources required for an FEA algorithm that involves 100 and ˜400,000,000 search points is vast.

Further efficiencies can be found by running a number of the Bayesian optimizations and FEA algorithm analyses of step 5 in parallel rather than in purely sequential manner. By way of example, a batch size of 3 was found to have minimal effect on accuracy but a significant improvement in speed.

### Method of Manufacture of Optimized Component

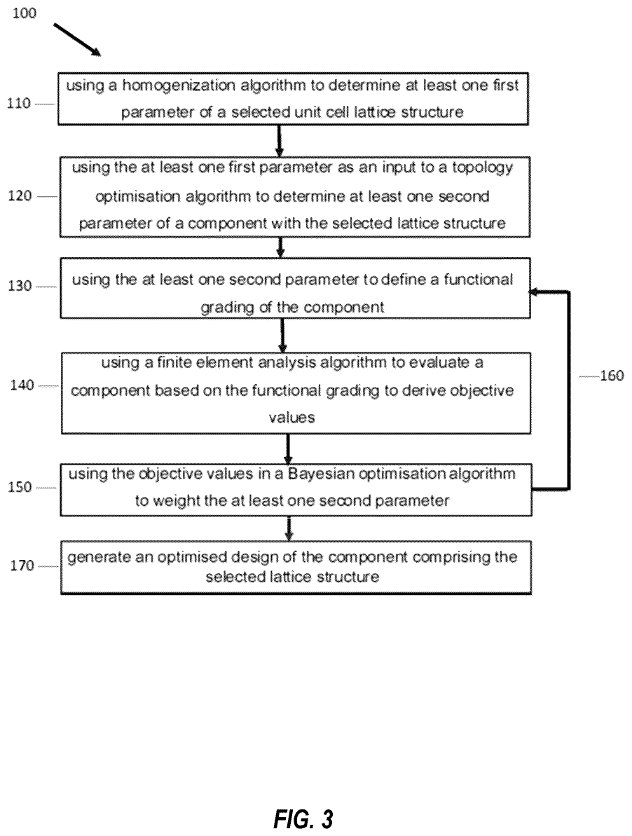

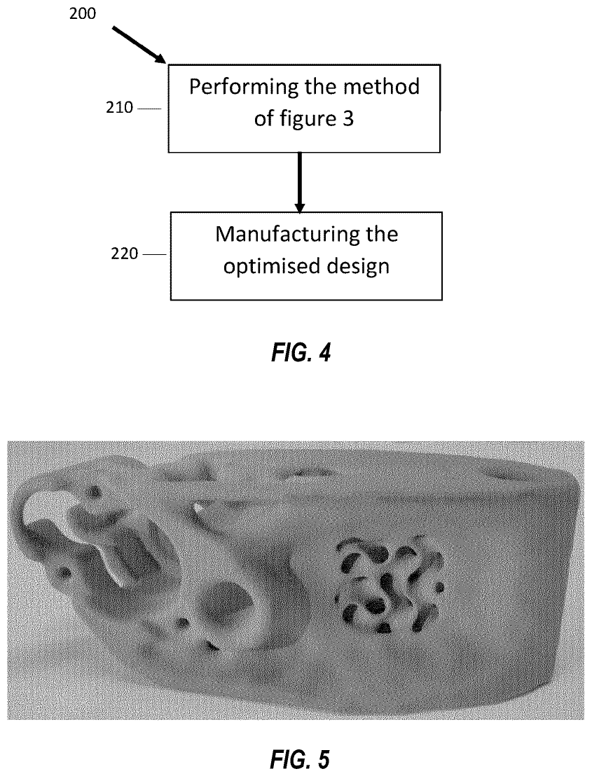

The algorithm of FIG. 3 can be used as part of a method for manufacturing (method 200) the optimized design of the component, as shown in FIG. 4. After the component has been optimized by performing the method of FIG. 3 (step 210), it is manufactured (step 220) using an additive manufacturing process such as MJF or SLS.

Two different components comprising infill lattice regions, VF30 and VF50, whose initial geometries were obtained from TO (i.e. step 120 of FIG. 3) with target volume fractions of 30% and 50% compared to design volume of the component, respectively. Gyroid unit cells were selected for the designs given their favorable properties in respect of stiffness, heat dispersion, and post MJF powder removal. The constraints were set to be the same for both the VF30 and VF50: 1 mm for the displacement and 50% for the retained mass (expressed as a fraction of the initial design volume mass). These constraints aimed to focus the candidate generation in a small region of the objective space, where all points meet the constraints on mass and displacement. Taking into account the constraints, objectives and loading conditions specific to the component, and applying the functional grading optimization (i.e. steps 130 to 160) of FIG. 3, both designs were optimized in 100 trials (i.e. search points), with an initial random (Sobol) batch of 9 trials. A comparison in Table 1 to TO designs with equivalent retained mass (m_{retained}) shows the advantages of the functional grading optimization.

TABLE 1
Comparison of optimal functionally graded
designs and topology optimized designs

| Case | m_{retained} | uₘₐₓ (mm) | σ_{VM, max} (MPa) | A/V (mm⁻¹) |
|---|---|---|---|---|
| Topology optimised | 0.399 | 0.230 | 2.000 | 0.251 |
| VF30 - | 0.399 | 0.247 | 3.075 | 0.382 |
| Optimal infill | | | | |
| Topology optimised | 0.473 | 0.180 | 1.792 | 0.225 |
| VF50 - | 0.475 | 0.205 | 2.384 | 0.462 |
| Optimal infill | | | | |

On the one hand, the VF30 latticed design experiences 7% higher maximum displacement (μₘₐₓ) and 54% higher maximum stress (σ_{VM,max}), while these numbers are 14% and 33% for VF50, respectively. It is important to note that the maximum displacement and maximum stress values of the VF30 and VF50 still correspond to safety factors of 12 and 9, respectively.

On the other hand, the introduction of the infill lattice resulted in a significant increase of the surface area to volume ratios (A/V). For VF30 this was a 52%, while for VF50 a 105% increase. This corresponds to a significant increase in the rate of heat dissipation during the printing process of the latticed components, hence heat warping is reduced during and MJP printing process, which in turn results in a printed component meeting acceptable manufacturing tolerances and constraints. FIG. 5 shows such a component corresponding to the VF30 design that has been manufactured via an MJF process.

VF30 and VF50 could be used as a component/part of a load-handling device.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The aspects of the present disclosure can take the form of an entirely hardware embodiment, an entirely software embodiment or an embodiment containing both hardware and software elements. In a preferred embodiment, the aspects are implemented in software.

Furthermore, the aspects of the present disclosure can take the form of a computer program embodied as a computer-readable medium having computer executable code for use by or in connection with a computer. For the purposes of this description, a computer readable medium can be any tangible apparatus that can contain, store, communicate, propagate, or transport the program for use by or in connection with the computer. Moreover, a computer-readable medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The flow diagrams in the figures illustrate the architecture, functionality, and operation of possible implementations of methods according to various embodiments of the present aspects. In this regard, each block in the flow diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the flow diagrams, and combinations of blocks in the flow diagrams, can be implemented by special purpose hardware-based systems that perform the specified functions or acts, or combinations of special purpose hardware and computer instructions.

It will be understood that the above description of is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this disclosure.

What is claimed is:

1. A computer-implemented method for optimizing a design of a component, the method comprising:
a) using a homogenization algorithm to determine at least one first parameter of a selected unit cell lattice structure;
b) using the at least one first parameter as an input to a topology optimization algorithm to determine at least one second parameter of the component with the selected unit cell lattice structure;
c) using the at least one second parameter to define a functional grading of the component;
d) using a finite element analysis algorithm to evaluate the component based on the functional grading to derive objective values;
e) using the objective values in a Bayesian optimization algorithm to weight the at least one second parameter; and
f) iteratively performing steps c) to e) to generate an optimized design of the component comprising the selected unit cell lattice structure.

2. The computer-implemented method of claim 1, wherein the at least one first parameter comprises one or more of:
a penalty exponent that characterizes a relationship between a stiffness and a density of the selected unit cell lattice structure;
a design domain that defines design and non-design volumes of the component;
loading conditions; and
boundary conditions.

3. The computer-implemented method of claim 1, wherein the at least one second parameter comprises one or more of:
a topology optimized density/grayscale field;
a shape of the component; and
a stress field.

4. The computer-implemented method of claim 3, wherein the topology optimized density/greyscale field and the stress field are combined to form the functional grading.

5. The computer-implemented method of claim 4, wherein the functional grading is defined by:
$$ℱ ( x , y , z ) = {w}_{1} \cdot 𝒳 ( x , y , z ) + ( 1 - {w}_{1} ) \cdot 𝒴 ( x , y , z )$$
where [symbol] (x, y, z) represents the topology optimized density/greyscale field, [symbol] (x, y, z) represents the stress field, and w₁ is a weighting factor to weight the at least one second parameter.

6. The computer-implemented method of claim 4, wherein the functional grading is defined by:
$$ℱ ( x , y , z ) = [ {w}_{o} {w}_{1} {w}_{2} {w}_{3} {w}_{4} {w}_{5} ] [ \begin{matrix}1 \\ 𝒳 \\ 𝒴 \\ {𝒳}^{2} \\ {𝒴}^{2} \\ 𝒳𝒴\end{matrix} ]$$
where [symbol] (x, y, z) represents the topology optimized density/greyscale field, [symbol] (x, y, z) represents the stress field, and w₀, w₁, w₂, w₃, w₄, w₅ are weighting factors to weight the at least one second parameter.

7. The computer-implemented method of claim 6, wherein
$$ℱ ( x , y , z ) = [ {w}_{o} {w}_{1} {w}_{2} {w}_{3} {w}_{4} {w}_{5} ] [ \begin{matrix}1 \\ 𝒳 \\ 𝒴 \\ {𝒳}^{2} \\ {𝒴}^{2} \\ 𝒳𝒴\end{matrix} ]$$
is constrained by the following equation:
$${ℱ}^{*} ( x , y , z ) = min ( max ( ℱ ( x , y , z ) , 0 ) , 1 ) .$$

8. The computer-implemented method of claim 6, wherein an average value of [symbol] (x, y, z) within a lattice region of the component is constrained to [0, 1], wherein the average value is defined by:
$$𝔼ℱ ( x , y , z ) = [ {w}_{o} {w}_{1} {w}_{2} {w}_{3} {w}_{4} {w}_{5} ] [ \begin{matrix}1 \\ 𝔼 [ 𝒳 ] \\ 𝔼 [ 𝒴 ] \\ 𝔼 [ {𝒳}^{2} ] \\ 𝔼 [ {𝒴}^{2} ] \\ 𝔼 [ 𝒳𝒴 ]\end{matrix} ] ,$$
where
$$𝔼 [ 𝒳 ( x , y , z ) ] = \frac{{\int }_{{V}_{LR}} 𝒳 ( x , y , z ) dV}{{V}_{LR}} , 𝔼 [ 𝒴 ( x , y , z ) ] = \frac{{\int }_{{V}_{LR}} 𝒴 ( x , y , z ) dV}{{V}_{LR}} , \\ 𝔼 [ {𝒳}^{2} ( x , y , z ) ] = \frac{{\int }_{{V}_{LR}} 𝒴 ( x , y , z ) dV}{{V}_{LR}} , 𝔼 [ {𝒴}^{2} ( x , y , z ) ] = \frac{{\int }_{{V}_{LR}} {𝒴}^{2} ( x , y , z ) dV}{{V}_{LR}} , \\ and 𝔼 [ 𝒳𝒴 ( x , y , z ) ] = \frac{{\int }_{{V}_{LR}} 𝒳𝒴 ( x , y , z ) dV}{{V}_{LR}} ,$$
where V_{LR} is a volume in the lattice region of the component.

9. The computer-implemented method of claim 1, wherein generating the optimized design comprises generating a plurality of optimized designs; and the method further comprises:
generating a Pareto front from the plurality of optimized designs; and
selecting one of the optimized designs from the Pareto front using a technique for order preference by similarity to an ideal solution, TOPSIS, algorithm.

10. The computer-implemented method of claim 1, wherein steps c) to e) are run in parallel to evaluate a number of components concurrently.

11. The computer-implemented method of claim 1, wherein the component comprises an infill lattice structure.

12. A method of manufacturing a component, wherein the method comprises:
obtaining an optimized design of the component by:
a) using a homogenization algorithm to determine at least one first parameter of a selected unit cell lattice structure;
b) using the at least one first parameter as an input to a topology optimization algorithm to determine at least one second parameter of the component with the selected unit cell lattice structure;
c) using the at least one second parameter to define a functional grading of the component;
d) using a finite element analysis algorithm to evaluate the component based on the functional grading to derive objective values;
e) using the objective values in a Bayesian optimization algorithm to weight the at least one second parameter; and
f) iteratively performing steps c) to e) to generate an optimized design of the component comprising the selected unit cell lattice structure; and manufacturing the optimized design of the component.

13. The method of claim 12, wherein a topology optimized density/greyscale field and a stress field are combined to form the functional grading, by at least weighting the topology optimized density/greyscale field.

14. The method of claim 13, wherein a search space of the functional grading is limited to a 6-dimensional hypercube.

15. The method of claim 14, wherein the functional grading is constrained to a range of [0,1].

16. The method of claim 14, wherein an average value of the functional grading within a lattice region of the component is constrained to [0,1].

17. The method of claim 12, wherein the component is manufactured using additive manufacturing such as Multi Jet Fusion or Selective Laser Sintering.

18. A computer program comprising instructions which, when executed by a computer, cause the computer to:
a) using a homogenization algorithm to determine at least one first parameter of a selected unit cell lattice structure;
b) using the at least one first parameter as an input to a topology optimization algorithm to determine at least one second parameter of the component with the selected unit cell lattice structure;
c) using the at least one second parameter to define a functional grading of the component;
d) using a finite element analysis algorithm to evaluate the component based on the functional grading to derive objective values;
e) using the objective values in a Bayesian optimization algorithm to weight the at least one second parameter; and
f) iteratively performing steps c) to e) to generate an optimized design of the component comprising the selected unit cell lattice structure.

19. A data processing system comprising a memory comprising computer-executable instructions; and a processor configured to execute the computer-executable instructions and cause the data processing system to:
a) using a homogenization algorithm to determine at least one first parameter of a selected unit cell lattice structure;
b) using the at least one first parameter as an input to a topology optimization algorithm to determine at least one second parameter of the component with the selected unit cell lattice structure;
c) using the at least one second parameter to define a functional grading of the component;
d) using a finite element analysis algorithm to evaluate the component based on the functional grading to derive objective values;
e) using the objective values in a Bayesian optimization algorithm to weight the at least one second parameter; and
f) iteratively performing steps c) to e) to generate an optimized design of the component comprising the selected unit cell lattice structure.

20. A mobile grocery picking robot or a load handling device having a component designed manufactured by:
a) using a homogenization algorithm to determine at least one first parameter of a selected unit cell lattice structure;
b) using the at least one first parameter as an input to a topology optimization algorithm to determine at least one second parameter of the component with the selected unit cell lattice structure;
c) using the at least one second parameter to define a functional grading of the component;
d) using a finite element analysis algorithm to evaluate the component based on the functional grading to derive objective values;
e) using the objective values in a Bayesian optimization algorithm to weight the at least one second parameter;
f) iteratively performing steps c) to e) to generate an optimized design of the component comprising the selected unit cell lattice structure; and
g) manufacturing the optimized design of the component.
